(19) United States
(12) Patent Application Publication
(10) Pub. No.: US 2008/0077657 A1
(43) Pub. Date: Mar. 27, 2008

(54) TRANSACTION TAKEOVER SYSTEM

(75) Inventors: Masatoshi Tagami, Kanagawa-ken (JP); Katsuyoshi Yamamoto, Tokyo (JP)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/776,590

(22) Filed: Jul. 12, 2007

(30) Foreign Application Priority Data
Jul. 21, 2006 (JP) 2006-198976

(51) Int. Cl. G06F 15/16

(52) U.S. Cl. 709/203

(57) ABSTRACT

To provide transaction processing for continuing processing without returning an error to a requestor and to make a system flexible by programmably configuring rollback and reprocessing, a system includes a request proxy device for transferring a request sent from a requestor terminal to a first server, a request information management device for receiving terminal request information from the request proxy device and storing the terminal request information, and a connection proxy device for relaying a processing request sent from the first server to a backend server or another external device to manage connection information. The request proxy device detects a server failure, reads out the terminal request information from the request information management device, and sends the terminal request information to second servers.

### FIELD OF THE INVENTION

The present invention relates to transaction takeover systems. More specifically, the present invention relates to a system and a method for automatically continuing unfinished transactions at the time of failure or the like in a multimode environment.

### BACKGROUND

Recently, the role of highly reliable servers that process many transactions in a client-server system in a network environment has become increasingly important. Network failures or server failures in such an environment may cause serious social problems depending on kinds of business application. Accordingly, various techniques enabling a smooth recovery from server failures have been proposed.

For example, Japanese Unexamined Patent Application Publication No. 2003-16041 discloses a system, a server device, a client device, and a cooperative processing method for guaranteeing that, regarding two operations that are correlated with each other and are executed on different devices, both of the two operations are executed once. Upon detecting a communication error, a client re-sends the same processing request as the previous one to a server. Upon re-receiving a processing request having the same identification information as a completed first operation, a server sends a completion notification for the first operation to the client without performing the first operation. Thus, by re-sending the processing request, the client can receive the completion notification while avoiding a repetition of the first operation, and perform a second operation even when the client could not receive the completion notification due to network failures or the like. It is described that, as a result, both of the first operation and the second operation are guaranteed to be performed only once.

In addition, as another example, Japanese Unexamined Patent Application Publication No. 2004-32224 discloses a system and a method for transparently switching from an active computer to a standby computer by monitoring (sniffing) input/output packets for operations of network transaction requests directed to the active computer when the active computer, having internal transaction queues, has entered a failure state.

In such systems, it is necessary that a restart of an unfinished transaction operation is performed without, being noticed by a requestor (generally, a client) (i.e., transparent to the requestor) and overlapped operations for the requestor is not caused at the time of a recovery from a server failure.

However, a method described in Japanese Unexamined Patent Application Publication No. 2003-16041 requires a client to detect an error and to re-send the same processing request as the previous one, which does not necessarily realize transparency to requestors. In addition, in a method described in Japanese Unexamined Patent Application Publication No. 2004-32224, in case that a failure occurs while processing a transaction, de-queued from internal queues of a server, by user logic on a server process, the operation is rolled back (canceled) and is performed again from the start. Thus, this method cannot be applied to cases other than a case where the operation can be simply rolled back and started over.

### SUMMARY

The present invention solves the foregoing problems. It is an object of the present invention to provide a transaction processing method for continuing an unfinished operation without sending an error back to a requestor. Furthermore, it is an object of the present invention to provide a flexible system by programmably configuring rollback and reprocessing and a method for the same.

The present invention provides systems, methods, and programs having the following solving means.

According to a first embodiment of the present invention, a system for allowing one or more second servers to take over processing of a first server in case that a failure occurs in the first server that processes a request sent from a requestor terminal includes a request proxy device, a request information management device, and a connection proxy device. The request proxy device receives terminal request information regarding the request sent from the requestor terminal, and transfers the request to the first server. The request information management device receives the terminal request information from the request proxy device, and stores the terminal request information. The connection proxy device connected to the first server relays a processing request sent from the first server to an external processing device to manage connection information between the first server and the external processing device.

This system is characterized as follows: in response to detecting a failure in the first server, the request proxy device reads out the terminal request information from the request information management device, and sends the terminal request information to the one or more second servers; and the one or more second servers continue processing the request sent from the requestor terminal by using the terminal request information, send to the connection proxy device the processing request that is directed to the external processing device by using the connection information, and send a processing result of the request to the request proxy device.

According to such a configuration, the request proxy device transfers a request directed to the server from the requestor terminal as a proxy. At this time, information of the requestor terminal relating to the request (the terminal request information) is stored in the request information management device. In addition, when the server requests a connected external device (e.g., a backend database server, an external device other than the server, or the like) to perform processing, the connection proxy device that manages the connection information relays the communication between the server and the external processing device.

That is, the request proxy device generally serves to transfer the request and to detect a server failure. In addition, the request information management device stores, after sequentially acquiring various kinds of information regarding the request necessary for the recovery, the information, and sends the information to the request proxy device when necessary. Furthermore, the connection proxy device manages the link information (also referred to as connection information) of the external processing device. By configuring the system in such a manner, the request proxy device, the request information management device, and the connection proxy device manage requestor information and status of the external processing device while sandwiching servers for processing and continuing the request, and operations can be efficiently performed in a distributed fashion at the time of the server failure and the recovery.

Moreover, as an additional embodiment of the above invention, if the request sent from the requestor is constituted by a plurality of transactions, completion status information and recovery information necessary for recovering the transaction are sequentially sent to the request information management device from the server in response to the completion of the each transaction. The request information management device can manage the transactions and the request synchronously.

According to another embodiment of the present invention, a method for allowing one or more second servers to take over processing of a first server in case that a failure occurs in the first server that processes a request sent from a requestor terminal, by using one or more proxy devices that relay communication between the requestor terminal and the first server or the one or more second servers, is provided which includes receiving a request directed to the first server sent from the requestor terminal, receiving and storing terminal request information regarding the request sent from die requestor terminal, sending the request sent from the requestor terminal to the first server, in response to an issuance of a processing request sent from the first server to the external processing device, relaying the processing request to manage connection information between the first server and the external processing device, detecting a failure in the first server, and in response to detecting the failure, reading out the terminal request information, and sending the terminal request information to the one or more second servers. The one or more second servers continue the processing corresponding to the request sent from the requestor terminal using the terminal request information.

According to such a configuration, a method for enabling a more flexible hardware configuration and enabling the one or more proxy devices to provide advantages similar to those of the first embodiment of the present invention can be provided.

In still another embodiment of the present invention, a computer program product in a computer readable medium for allowing one or more second servers to take over processing of a first server in case that a failure occurs in the first server, one of a plurality of servers in a server system including the plurality of servers that process a request sent from a requestor terminal, wherein the computer readable medium is associated with one or more proxy devices that relay communication between the requestor terminal and the first server or the one or more second servers, is provided which includes receiving a request directed to the first server sent from the requestor terminal, receiving and storing terminal request information regarding the request sent from the requestor terminal, sending the request sent from the requestor terminal to the first server, in response to an issuance of a processing request sent from the first server to an external processing device, relaying the processing request to manage connection information between the first server and the external processing device, detecting a failure in the first server, and in response to detecting the failure, reading out the terminal request information, and sending the terminal request information to the one or more second servers. The one or more second servers continue the processing corresponding to the request from the requestor terminal using the terminal request information.

According to such a configuration, a computer program product that allows the one or more proxy devices to execute a method indicated by the above system or method can be provided.

In addition, as an application embodiment of the present invention, a system, including a plurality of servers that process a request sent from a requestor terminal connected to a network, for distributing processing of a first server to one or more second servers in accordance with a load of the first server, one of the plurality of servers, includes a request proxy device, a request information management device, a connection proxy device, and a transaction monitoring device. The request proxy device receives terminal request information regarding the request sent from the requestor terminal, transfers the request to the first server, and distributes the processing load to the one or more second servers. The request information management device receives the terminal request information from the request proxy device, and stores the terminal request information. The connection proxy device connected to the first server relays a processing request sent from the first server to an external processing device to manage connection information between the first server and the external processing device. The transaction monitoring device monitors a transaction load of the plurality of servers.

This system is characterized as follows: the transaction monitoring device detects an occurrence of a predetermined overload in the first server; the request proxy device reads out, upon receiving a notification of detection of the overload, the terminal request information stored in the request information management device, and sends the terminal request information to the one or more second servers; and the one ore more second servers continue processing the request sent from the requestor terminal by using the terminal request information, send to the connection proxy device the processing request that is directed to the external processing device by using the connection information, and send a processing result for the request to the request proxy device.

That is, this embodiment does not provide only a simple server failure recovery system. In this embodiment, the transaction monitoring device monitors a load (an amount of processing of the transactions) of the server, thereby detecting an overloaded server. The transaction monitoring device informs the request proxy device of the overloaded server, whereby the processing of the overloaded server can be distributed to other servers having a relatively low load. The request proxy device, the request information management device, and the connection proxy device perform processing similar to that performed at the time of an occurrence of the server failure. This system, in combination with an autonomic system, can adjust the number of servers (the number of nodes) on demand and can constitute a flexible server system.

According to the present invention, a system or the like capable of continuing and normally completing processing for an unfinished request can be provided. Since the normal processing can be completed without a requestor noticing an occurrence of an error here, trust and reliability of services provided by the system can be maintained at a high level, the overhead at the time of normalcy can be kept relatively low, and effects to responses can be reduced.

Furthermore, as an application of the present invention, it is possible to easily take over unfinished processing to other nodes immediately and to decrease the number of nodes instantly by combining the system with an autonomic technology that increases or decreases the number of nodes (the number of servers) to automatically adjust processing capability of the servers.

### BRIEF DESCRIPTION OF THE DRAWINGS

The present invention will be described below with reference to the drawings, wherein:

FIG. 1 is a diagram showing an overview of a server system 10 according to a first embodiment of the present invention;

FIG. 2 is a diagram showing an overview of a server system 30 according to a second embodiment of the present invention;

FIG. 3 is a diagram showing an overview of a server system 40 according to a third embodiment of the present invention;

FIG. 4 is a diagram showing a process flow in a case where a system operates normally in first and second embodiments of the present invention;

FIG. 5 is a diagram showing a process flow at the time of an occurrence of abnormality in a system in first and second embodiments of the present;

FIG. 6 is a diagram showing a process flow in a request proxy component 4 in first and second embodiments of the present invention after detection of a server failure;

FIG. 7 is a diagram showing a flow of a start of a recovery operation in a request information management component 5 in first and second embodiments of the present invention;

FIG. 8 is a diagram showing a process flow (completion of a recovery operation) in a request information management component 5 in first and second embodiments of the present invention;

FIG. 9 is a diagram showing a process flow in a support library on a Web/AP server 2 in first and second embodiments of the present invention;

FIG. 10 is a diagram showing a process flow in a connection proxy component 6 in first and second embodiments of the present invention; and

FIG. 11 is a diagram showing an information processing apparatus 100 as an example of a typical hardware configuration of a server or each component device of the present invention.

### DETAILED DESCRIPTION

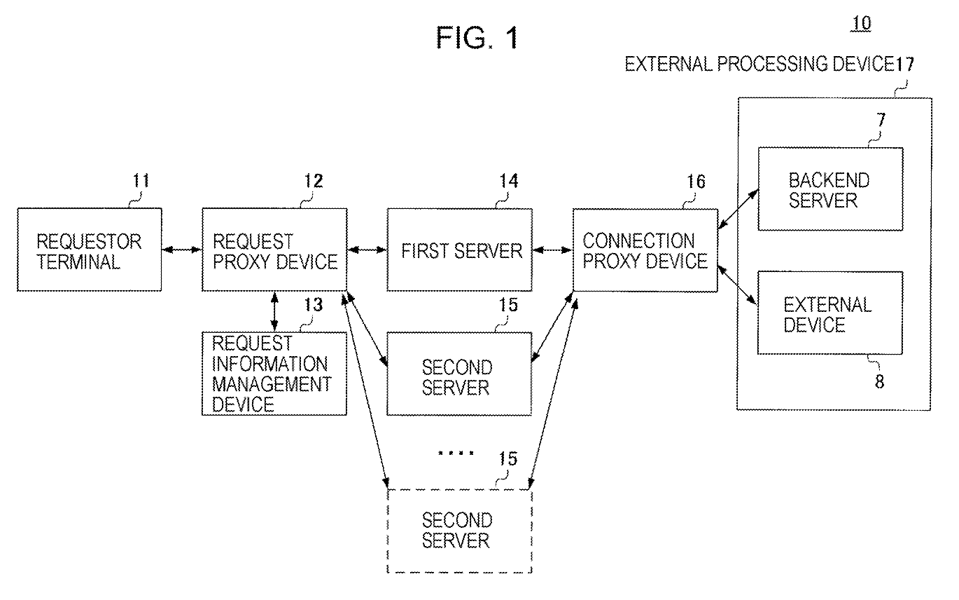

FIG. 1 is a diagram showing an overview of a server system 10 according to a first embodiment of the present invention. This server system 10 includes a requestor terminal 11, a first server 14 (an active server) for processing requests sent from the requestor terminal, and a second server 15 (a standby server) 15 that is a backup server for an occurrence of a failure. Although only one requestor terminal 11 is shown in this figure, the server system 10 may obviously include a plurality of terminals. Additionally, two servers, the first server 14 and the second server 15, are shown as those for receiving requests from the requestor terminal 11. However, as shown by a broken line, there may be a plurality of second servers 15.

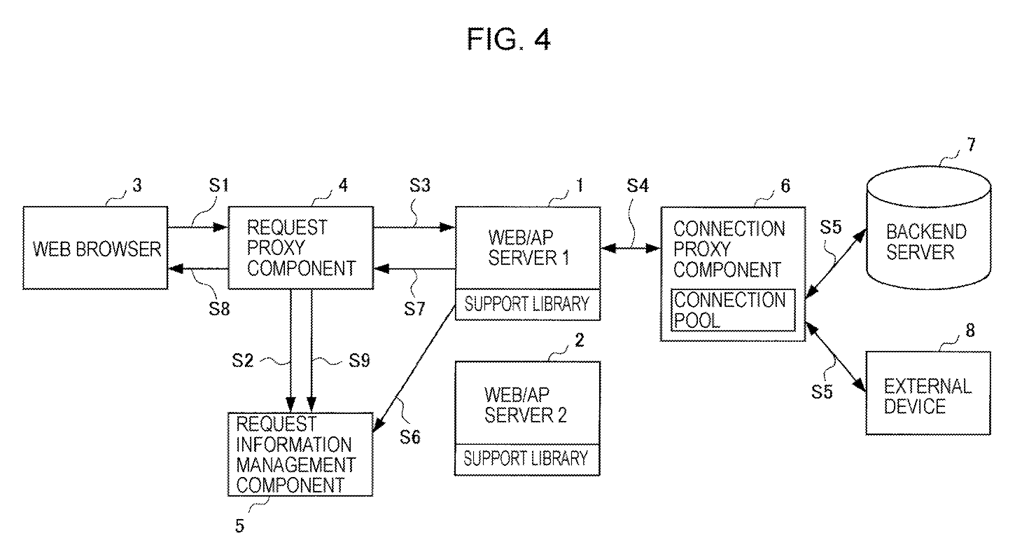

In this embodiment, a request proxy device 12 and a request information management device 13 are provided between the requestor terminal 11 and the first and second servers 14 and 15. Functions of the request proxy device 12 and the request information management device 13 will be described later. In addition, a connection proxy device 16 is provided between the first and second servers 14 and 15 and an external processing device 17 (a back end server 7 or an external device 8). The backend server 7 is a sever for receiving requests from the first server 14 or the second server 15 and containing database necessary for processing. The external device 8 indicates any external device that is not a server like the backend server 7 and is operated from requestors. Operations of this server system 10 will be described in details in drawings following FIG. 4.

Additionally, in the system shown in FIG. 1, each of the request proxy device 12, the request information management device 13, and the connection proxy device 16 is shown as a single device. However, each of those devices may be configured to have a multiplex structure (a dual structure or a redundant structure) in preparation for failures in each device.

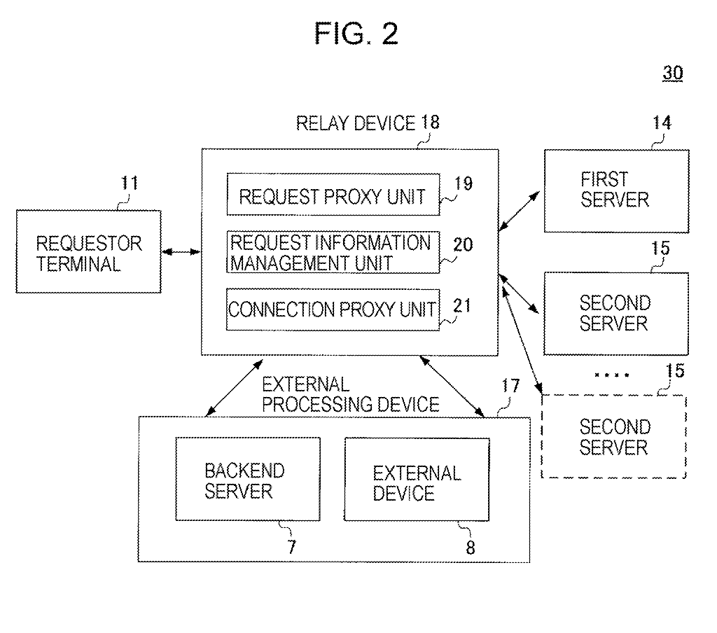

FIG. 2 is a diagram showing an overview of a server system 30 according to a second embodiment of the present invention. In this server system 30, the request proxy device 12, the request information management device 13, and the connection proxy device 16 shown in FIG. 1 are collectively included in a single relay device 18. A request proxy unit 19, a request information management unit 20, and a connection proxy unit 21 correspond to each device of FIG. 1. In this configuration, the necessary hardware configuration is reduced compared with the system of FIG. 1. However, necessity of failure precautions of the relay device 18 may be increased. On the other hand, although a distributed system configuration shown in FIG. 1 needs more hardware configurations, a risk of failures in the relay device 18 becomes lower. However, as known from the following description, processing of these relay devices (proxy units) is simple in either configuration and the overhead is relatively small.

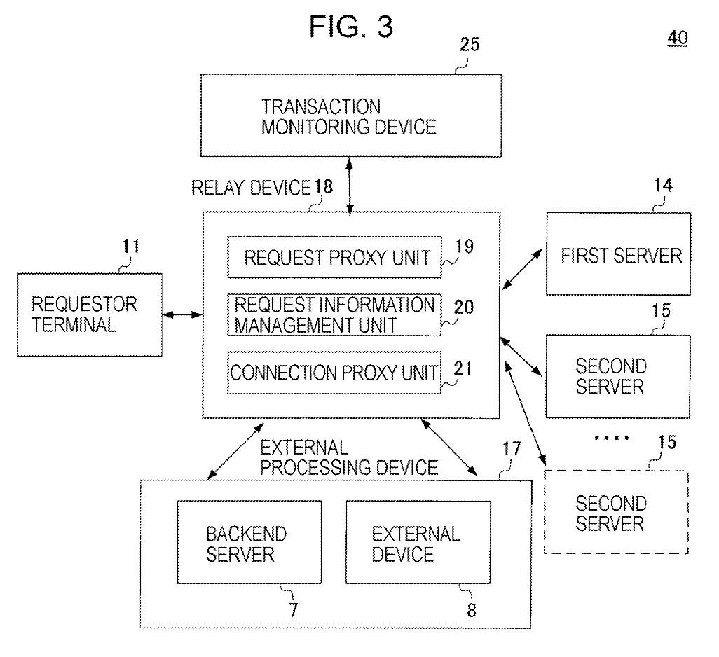

FIG. 3 is a diagram showing an overview of a server system according to a third embodiment of the present invention. In this system, by combining the system with an autonomic technology that increases or decreases the number of nodes (the number of servers) to automatically adjust processing capabilities of servers, it is possible to take over unfinished processing by another node immediately and to decrease the number of nodes instantly. More specifically, for example, a transaction monitoring device 25 for monitoring a transaction load is added to the system of FIG. 2 (the same applies to FIG. 1), whereby not only the failures in servers are managed but also transaction loads of the server are monitored. A transaction monitoring device 25 may prestore a predetermined value for an amount of transactions and may determine the transaction loads. That is, the transaction monitoring device 25 prestores an appropriate load amount for each server. Upon detecting that the processing load of a server exceeds (or is likely to exceed) the appropriate load, the transaction monitoring device 25 notifies the relay device 18 to add an additional server to the system and distribute the entire load. Conversely, if the load reduces later (e.g. late at night) and the number of the servers becomes surplus, the transaction monitoring device 25 makes each component of the relay server 18 to recognize that the excessive server has failed, thereby isolating the excessive server. Thus, most of processing operations provided by the systems shown in FIGS. 1 and 2 can be utilized without modification. That is, by making this transaction monitoring device 25 to work in cooperation with the above-described request proxy unit 19 (the request proxy device 12), the request information management unit 20 (the request information management device 13), and the connection proxy unit 21 (the connection proxy device 16), an autonomous adjustable computer system can be constructed easily. In particular, since a known autonomic technology has technically difficult problems at the time of isolating the server from the system, techniques of the present invention are extremely useful.

FIG. 4 is a diagram showing a process flow in a case where the system operates normally in the first and second embodiments of the present invention. Only hardware configurations differ between FIG. 1 and FIG. 2 and basic processing thereof is similar. In the following description, the request proxy device 12 in FIG. 1 and the request proxy unit 19 in FIG. 2 are collectively referred to as a request proxy component 4. Similarly, the request information management device 13 and the request information management unit 20 are collectively referred to as a request information management component 5. The connection proxy device 16 and the connection proxy unit 21 are collectively referred to as a connection proxy component 6. These components constitute a principal part of the present invention.

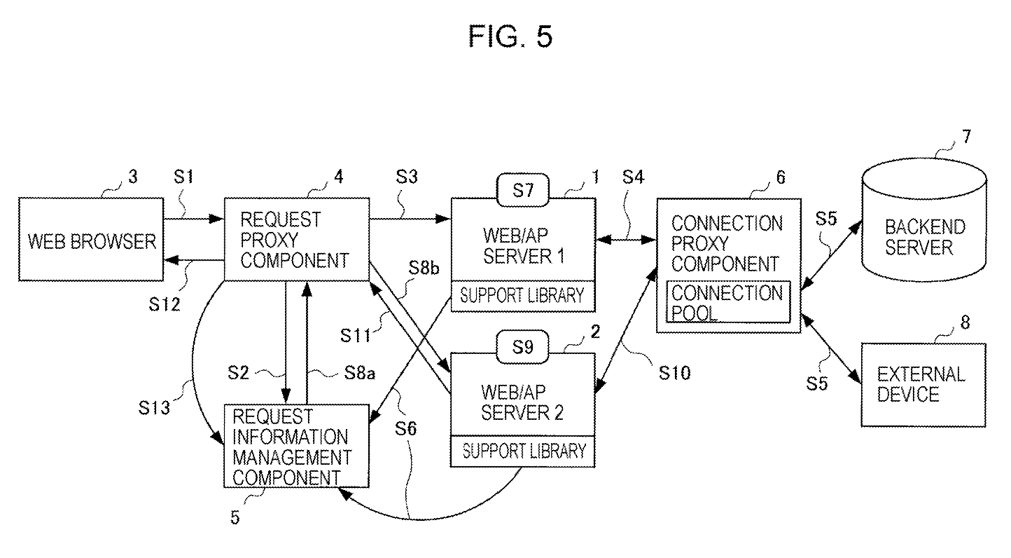

Hereinafter, description is given in detail for an example in which a Web browser 3 is used as an application on the requestor terminal 11. In addition, in FIGS. 4 and 5, STEP Sn denotes a data flow.

Processing in Normal State: Firstly, a request (generally, an HTTP request) containing request information is sent from the Web browser 3 (STEP S1). Then, the request proxy component 4 sends to the request information management component 5 a cookie ID relating to this request, data contained in the HTTP request, and information of a terminal on which the Web browser 3 operates. The request information management component 5 stores these data in a storage unit thereof (STEP S2).

Then, the request proxy component 4 sends the request to a Web/AP server 1 as a proxy server (STEP S3). Next, the Web/AP server 1 requests the connection proxy component 6 to send the request to a backend server 7 or an external device 8 (STEP S4). Furthermore, according to this request, the connection proxy component 6 transfers the processing request to the backend server 7 or the external device 8 (STEP S5). At this time, the connection proxy component 6 establishes a connection (session) to the backend server 7 and the external device 8 beforehand, and manages connection information of this session using a connection pool included in the connection proxy component 6. Once the session is established, the connection information thereof is held in the connection pool. With such a configuration, it is possible to minimize the overhead for establishment and termination of the session.

When one request contains a plurality of transactions, the Web/AP server 1 sends completion status to the request information management component 5 in response to the completion of each transaction, in addition, at this time, the Web/AP server 1 also sends information necessary for recovery (STEP S6). Next, the Web/AP server 1 sends a processing result for the transaction back to the request proxy component 4 (STEP S7). The request proxy component 4 sends the processing result for each request to the Web browser 3 on the basis of the terminal information regarding the Web browser 3 stored in the request information management component 5 (STEP S8). Lastly, the request proxy component 4 notifies the request information management component 5 of the completion of processing for this request. The request information management component 5 deletes the stored recovery information (STEP S9). These series of processing steps are realized by a group of modules in a support library, having dedicated APIs, provided on the Web/AP server.

FIG. 5 is a diagram showing a process flow at the time of an occurrence of abnormality in the system in the first and second embodiments of the present. Firstly, the Web browser 3 sends a request containing request information (STEP S1). Next, the request proxy component 4 sends to the request information management component 5 a cookie ID relating to this request, data contained in the HTTP request, and information of a terminal on which the Web browser 3 operates. The request information management component 5 stores these data (STEP S2).

Then, the request proxy component 4 sends the request to the Web/AP server 1 as a proxy server (STEP S3). Next, the Web/AP server 1 requests the connection proxy component 6 to send the request to the backend server 7 or the external device 8 (STEP S4). Furthermore, according to the request, the connection proxy component 6 transfers the processing request to the backend server 7 or the external device 8 (STEP S5). At this time, the connection proxy component 6 establishes a connection (session) to the backend server 7 and the external device 8 beforehand, and manages connection information of this session using the connection pool included in the connection proxy component 6. When one request contains a plurality of transactions, the Web/AP server 1 sends completion status to the request information management component 5 in response to the completion of each transaction. In addition, at this time, the Web/AP server 1 also sends information necessary for recovery (STEP S6). The processing steps (STEPs S1 to S6) performed so far are the same as those performed at the time of normalcy show in FIG. 3.

Processing in Abnormal State: At this time, suppose that a failure occurs in the Web/AP server 1 (STEP S7). The request proxy component 4 detects this failure. After the detection of the occurrence of the failure, the request proxy component 4 reads out the cookie information, the data contained in the HTTP request, the transaction completion information, and the recovery information stored in the request information management component 5 (STEP S8a), and sends a request to a Web/AP server 2 (STEP S8b).

The Web/AP server 2 includes a support library (an API library that is a group of processing modules for continuation of the processing). The Web/AP server 2 starts necessary rollback processing and processing of unfinished transactions using this support library to continue the processing (STEP S9). Additionally, when the Web/AP server 2 requests the connection proxy component 6 to send the request to the backend server 7 or the external device 8, the Web/AP server 2 uses the same connection as that used by the Web/AP server 1 and continues the transaction processing in the backend server 7 or the external devices (STEP S10).

The Web/AP server 2 sends the processing result for the transaction back to the request proxy component 4 (STEP S11). The request proxy component 4 sends the processing result for each request to the Web browser 3 on the basis of the terminal information regarding the Web browser 3 stored in the request information management component 5 (STEP S12) Lastly, the request proxy component 4 notifies the request information management component 5 of the completion of processing for this request. The request information management component 5 deletes the stored recovery information (STEP S13).

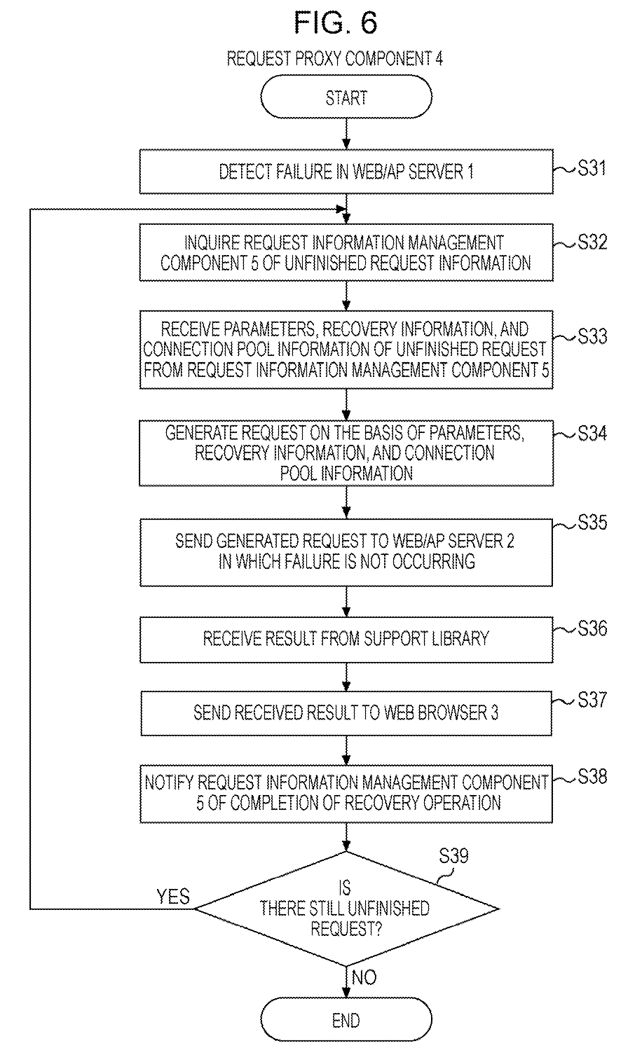

FIG. 6 is a diagram showing a process flow in the request proxy component 4 in the first and second embodiments of the present invention after the detection of the server failure. Firstly, at STEP S31, the request proxy component 4 detects a failure in a Web/AP server 1. A detection method is not specified here. Next, at STEP S32, the request proxy component 4 inquires the request information management component 5 of information of the unfinished request. Then, at STEP S33, the request proxy component 4 receives parameters, recovery information, and connection pool information of the unfinished request from the request information management component 5. Furthermore, at STEP S34, the request proxy component 4 generates a request on the basis of the parameters, the recovery information, and the connection pool information. At STEP S35, the request proxy component 4 sends the generated request to a support library of the Web/AP server 2 not having a failure. The request proxy component 4 receives a result from the support library (STEP S36), and sends the received result to the Web browser 3 (STEP S37). The request proxy component 4 notifies the request information management component 5 of the completion of the recovery operation (STEP S38). These steps S32 to S38 are performed for all of unfinished requests (STEP S39).

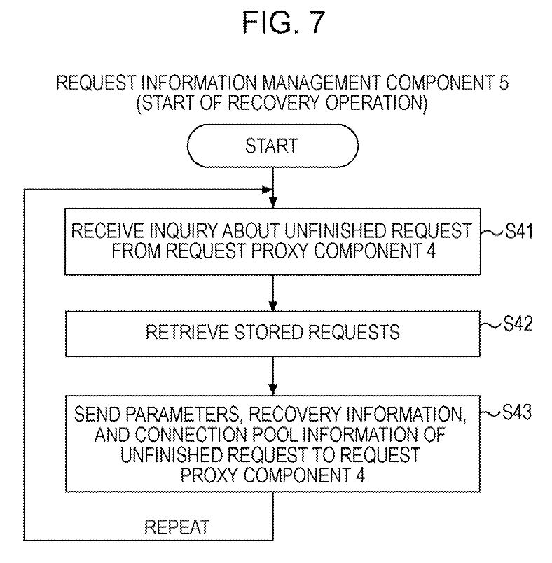

FIG. 7 is a diagram showing a start of a recovery operation in the request information management component 5 in the first and second embodiments of the present invention. At STEP S41, upon receiving an inquiry about an unfinished request from the request proxy component 4, the request information management component 5 retrieves stored requests (STEP S42), and sends to the request proxy component 4 parameters, recovery information, and connection pool information for the unfinished request (STEP S43). The request information management component 5 repeats these processing steps (STEPs S41 to S43).

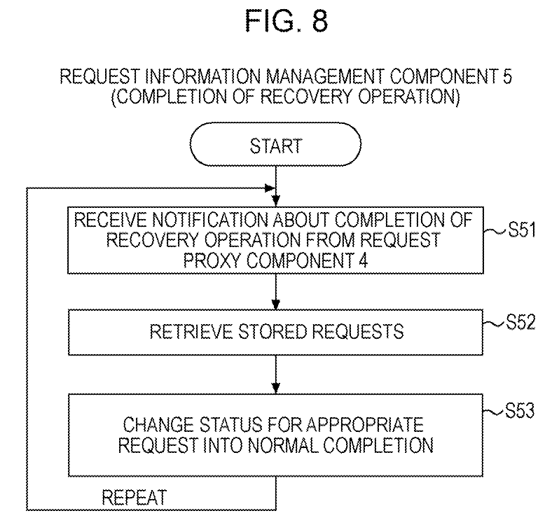

FIG. 8 is a diagram showing completion of a recovery operation in the request information management component 5 in the first and second embodiments of the present invention. Upon receiving the notification of completion of the recovery operation from the request proxy component 4 at STEP S51, the request information management component 5 retrieves stored requests (STEP S52). The request information management component 5 changes the statues for the corresponding request to normal completion (STEP S53). The request information management component 5 repeats these processing steps (STEPs S51 to S53).

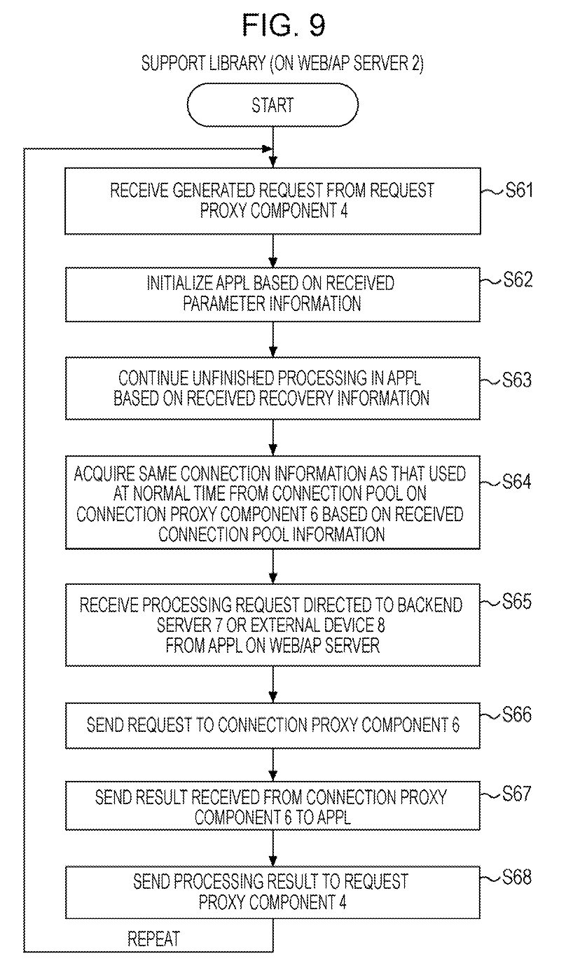

FIG. 9 is a diagram showing a process flow in the support library on the Web/AP server 2 in the first and second embodiments of the present invention. At STEP S61, the support library receives the generated request from the request proxy component 4. Then the support library initializes an application (APPL) on the basis of the received parameter information (STEP S62). Additionally, the support library continues the unfinished processing in the application on the basis of the received recovery information (STEP S63). Furthermore, the support library acquires the same connection information as that used at a normal time from the connection pool on the connection proxy component 6 on the basis of the received connection pool information (STEP S64). Next, the support library receives the processing request directed to the backend server 7 or the external device 8 from the application on the Web/AP server (STEP S65). Then, the support library sends the request to the connection proxy component 6 (STEP S66). The support library sends a processing result received from the connection proxy component 6 to the application (STEP S67). Lastly, the support library sends the processing result to the request proxy component 4 (STEP S68). The support library repeats the above-described steps (S61 to S68).

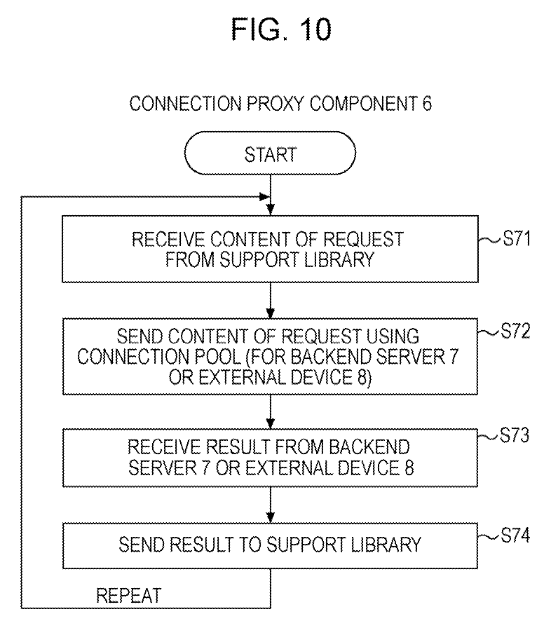

FIG. 10 is a diagram showing a process flow in the connection proxy component 6 in the first and second embodiments of the present invention. Firstly, upon receiving the request content from the support library (from the Web/AP server 1 or the Web/AP server 2) (STEP S71), the connection proxy component 6 sends the request content using the connection pool (for the backend server 7 or the external device 8) (STEP S72). Next, the connection proxy component 6 receives a processing result from the backend server 7 or the external device 8 (STEP S73). Then, the connection proxy component 6 sends the result to the support library (STEP S74). The connection proxy component 6 repeats the above-described steps (STEPs S71 to S74).

Characteristics of the above-described operations of each device or component shown in FIGS. 1 to 10 are summarized as follows:

1) The system is effective for failure recovery when a rollback operation is not suitable or impossible since the operation can be re-started in the middle thereof;

2) This system does not require preconditions for use of the system and can be utilized generally. This system can be applied to a backend server or an external device not having a concept of transactions, such as CGI, e.g., Perl, or sendmail;

3) The system is not affected by user logics since the system separates the functions for performing the transaction management from the user logics;

4) The method of the recovery operation does not depend on the system and can be set freely;

5) The system that prevents users from being aware of the failure can be constructed; and

6) The backend server and the external device are not affected by the Web/AP server.

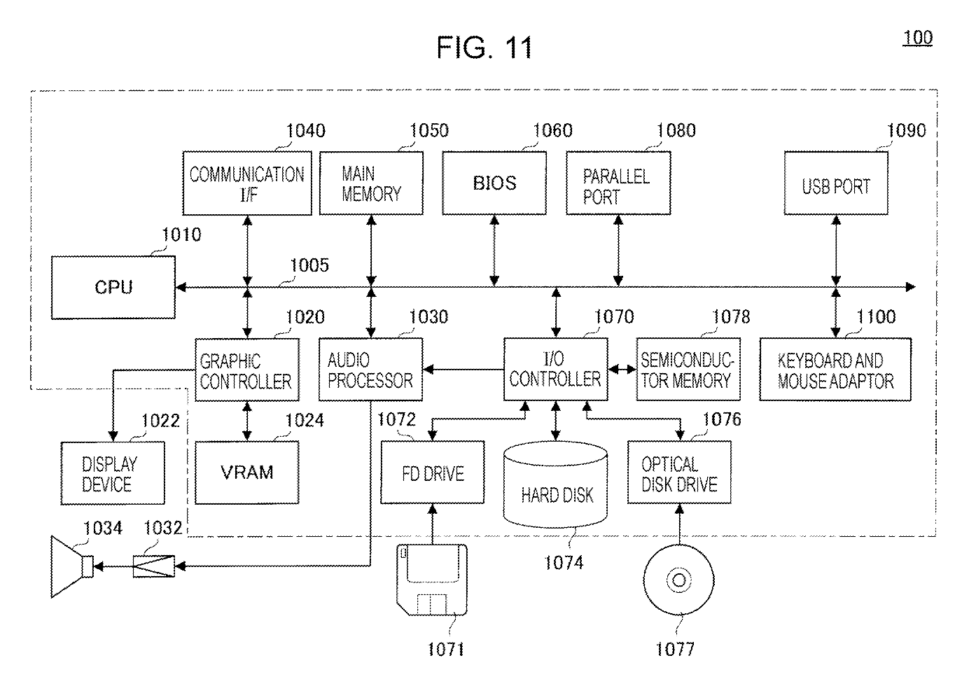

FIG. 11 is a diagram showing an information processing apparatus 100 as an example of a typical hardware configuration of a server or each device (including each component) described in FIG. 1 to FIG. 10. An example of a hardware configuration of this information processing apparatus 100 will be described below. The information processing apparatus 100 has a CPU (Central Processing Unit) 1010, a bus 1005, a communication I/F 1040, a main memory 1050, a BIOS (Basic Input Output System) 1060, a parallel port 1080, a USB port 1090, a graphic controller 1020, a VRAM 1024, an audio processor 1030, an I/O controller 1070, and an input unit such as a keyboard and mouse adaptor 1100. A flexible disk (FD) drive 1072, a hard disk 1074, an optical disk drive 1076, and a storage unit such as a semiconductor memory 1078 can be connected to the I/O controller 1070.

An amplification circuit 1032 and a speaker 1034 are connected to the audio processor 1030. In addition, a display device 1022 is connected to the graphic controller 1020.

The BIOS 1060 stores a boot program executed by the CPU 1010 at the time of booting of the information processing apparatus 100 and hardware-dependent programs depending on hardware of the information processing apparatus 100. The FD (flexible disk) drive 1072 reads programs or data from a flexible disk 1071, and supplies the programs or the data to the main memory 1050 or the hard disk 1074 through the I/O controller 1070.

For example, a DVD-ROM drive, a CD-ROM drive, a DVD-RAM drive, or a CD-RAM drive can be used as the optical disk drive 1076. In this case, it is necessary to use an optical disk 1077 corresponding to each drive. The optical disk drive 1076 reads programs or data from the optical disk 1077 and may supply the program or the data to the main memory 1050 or the hard disk 1074 through the I/O controller 1070.

Computer programs may be stored on a recording medium such as the flexible disk 1071, the optical disk 1077, or a memory card (not shown) and supplied to the information processing apparatus 100 by a user. The computer programs are read out from the recording medium through the I/O controller 1070 or are downloaded through the communication I/F 1040, thereby being installed in the information processing device 100 and executed. Since the operations that the computer programs cause the information processing apparatus to perform are the same as those in the server or each component device described in FIG. 1 to FIG. 10, description thereof is omitted.

The computer programs described above may be stored on external recording media, in addition to the flexible disk 1071, the optical disk 1077, or the memory card, a magneto-optical recording medium such as an MD and a tape medium can be used as the recording media. In addition, the computer programs may be supplied to the information processing apparatus 100 via a communication network using a storage device, such as a hard disk or an optical disk library, provided in a server system connected to a private communication network or the Internet as the recording medium.

The information processing apparatus 100 has been described in the above example. Functions similar to those of the above-described information processing apparatus 100 can be realized by installing programs, having the functions described regarding the information processing apparatus, in a computer, and causing the computer to function as the information processing apparatus. Accordingly, the information processing apparatus that is described as one embodiment of the present invention can be realized by a method and a computer program thereof.

Apparatus according to the present invention can be realized by hardware, software, or a combination of hardware and software. When the apparatus is embodied by the combination of hardware and software, an embodiment as a computer system having a predetermined program can be cited as a typical example. In such a case, the program is loaded to the computer system and executed, thereby causing the computer system to perform operations according to the embodiments of the present invention. This program may be constituted by a group of instructions representable by a given language, code, or description. Such a group of instructions enables the system to perform specific functions directly or after one of or both of (1) conversion to other languages, codes, or descriptions and (2) copying to other media is performed. Needless to say, the present invention includes not only such a program itself but also a program product having the program recorded on a medium within a scope thereof. The program for enabling functions of the present invention to be performed can be stored on any computer-readable medium, such as a flexible disk, an MO, a CD-ROM, a DVD, a hard disk drive, a ROM, an MRAM, and a RAM. To store such program on a computer-readable medium, the program can be downloaded from other computer systems connected through a communication network or copied from other media. Additionally, such a program may be stored on one or more recording media after being compressed or divided in to a plurality of groups.

While the present invention has been described using the embodiments and examples, the technical scope of the present invention is not limited to the scope described in the above embodiments. Various modifications or improvements can be added to the above-described embodiments. It is obvious from the appended claims that such modifications or improvements can be also included within the technical scope of the present invention.

What is claimed is:

1. A system for enabling one or more second servers to take over processing of a first server when a failure occurs in the first server that processes a request sent from a requestor terminal, the system comprising:
a request proxy device for receiving terminal request information regarding the request sent from the requestor terminal, and transferring the request to the first server;
a request information management device for receiving the terminal request information from the request proxy device, and storing the terminal request information; and
a connection proxy device connected to the first server for relaying a processing request sent from the first server to an external processing device to manage connection information between the first server and the external processing device;
wherein, in response to detecting a failure in the first server, the request proxy device reads out the terminal request information from the request information management device, and sends the terminal request information to the one or more second servers; and wherein the one or more second servers continue processing the request by using the terminal request information, send to the connection proxy device the processing request that is directed to the external processing device by using the connection information, and send a processing result of the request to the request proxy device.

2. The system according to claim 1, wherein if the request contains a plurality of transactions, the request information management device receives completion status information and recovery information of each transaction from the first server, in response to the completion of the each transaction.

3. The system according to claim 2, wherein the one or more second servers roil back an unfinished transaction at the time of taking over the processing of the first server, and send the processing result to the request proxy device in response to the completion of each of the rest of the plurality of transactions, and
wherein the request proxy device sends, in response to the completion of all of the plurality of transactions contained in the request, a processing result for the request to the requestor terminal on the basis of the terminal request information stored in the request information management device.

4. The system according to claim 2, wherein the terminal request information includes at least one of a cookie ID, data contained in an HTTP request, completion information of the each transaction, HTTP header information, a session ID, and recovery information of the each transaction.

5. The system according to claim 4, wherein the request information management device deletes the recovery information in response to the completion of the processing corresponding to the request.

6. The system according to claim 1, wherein the request proxy device, the request information management device, and the connection proxy device are configured to be a dual structure or a redundant structure.

7. A computer implemented method for enabling one or more second servers to take over processing of a first server when a failure occurs in the first server that processes a request sent from a requestor terminal, by using one or more proxy devices that relay communication between the requestor terminal and the first server or the one or more second servers, the method comprising:
receiving a request directed to the first server sent from the requestor terminal;
receiving and storing terminal request information regarding the request sent from the requestor terminal;
sending die request sent from the requestor terminal to the first server;
in response to an issuance of a processing request sent from the first server to an external processing device, relaying the processing request to manage connection information between the first server and the external processing device;
detecting a failure in the first, server; and
in response to detecting the failure, reading out the terminal request information, and sending the terminal request information to the one or more second servers;
wherein the one or more second servers continue the processing corresponding to the request from the requestor terminal using the terminal request information.

8. A computer program product in a computer readable medium for enabling one or more second servers to take over processing of a first server when a failure occurs in the first server that processes a request sent from a requestor terminal, wherein the computer readable medium associated with one or more proxy devices that relay communication between the requestor terminal and the first server or the one or more second servers, the computer program product comprising:
receiving a request directed to the first server sent from the requestor terminal;
receiving and storing terminal request information regarding the request sent from the requestor terminal;
sending the request sent from the requestor terminal to the first server;
in response to an issuance of a processing request sent from the first server to an external processing device, relaying the processing request to manage connection information between the first server and the external processing device;
detecting a failure in the first server; and
in response to detecting the failure, reading out the terminal request information, and sending the terminal request information to the one or more second servers;
wherein the one or more second servers continue the processing corresponding to the request from the requestor terminal using the terminal request information.

9. A system for distributing processing of a first server to one or more second servers in accordance with a load of the first server that processes a request sent from a requestor terminal, the system comprising:
a request proxy device for receiving terminal request information regarding the request sent from the requestor terminal, transferring the request to the first server, and distributing the processing load to the one or more second servers;
a request information management device for receiving the terminal request information from the request proxy device, and storing the terminal request information;
a connection proxy device connected to the first server for relaying a processing request sent from the first server to an external processing device to manage connection information between the first server and the external processing device; and
a transaction monitoring device for monitoring a transaction load of the plurality of servers,
wherein the transaction monitoring device detects an occurrence of a predetermined overload in the first server, and
wherein the request proxy device reads out, upon receiving a notification of detection of the overload, the terminal request information stored in the request information management device, and sends the terminal request information to the one or more second servers, wherein the one ore more second servers continue processing the request by using the terminal request information, send to the connection proxy device the processing request that is directed to the external processing device by using the connection information, and send a processing result for the request to the request proxy device.
